(19) United States
(12) Patent Application Publication
(10) Pub. No.: US 2005/0180075 A1
(43) Pub. Date: Aug. 18, 2005

(54) Maintaining minimum electrical service while preventing a blackout

(76) Inventor: William A. Simpson, Reseda, CA (US)

Correspondence Address: William A. Simpson, 7241 Yolanda Ave, Reseda, CA, 91335, US

(21) Appl. No.: 10/780,233

(22) Filed: Feb. 18, 2004

(51) Int. Cl. H02H 3/00

(52) U.S. Cl. 361/62

(57) ABSTRACT

This invention will instantly disconnect large blocks of electrical load from an overloaded power system grid while maintaining approximately ½ of a customers electrical circuits energized. This action takes place instantly and will avoid the slowing of the overloaded power system frequency to a point at which the power system will become unstable. At the present time with the unexpected loss of generation, blocks of electrical load are disconnected leaving customers without any service of power. All of the customers circuits are de-energized during the power system blackout. With this invention large blocks of electrical load will be disconnected from the overloaded power system while leaving the power system customers with approximately ½ of their electrical circuits energized.

### BACKGROUND OF THE INVENTION

1. Field of Invention

This invention relates to the automatic disconnecting of electrical load from an overloaded power system, while at the same time maintaining approximately 1/2 of normal electrical service to every customer.

2. Description of Related Art

The practice of disconnecting electrical load, today, during a power system overload emergency, is to completely disconnect customers. This sometimes results in a widespread blackout.

### BRIEF SUMMARY OF THE INVENTION

During a power system overload emergency this invention will avoid a blackout by providing service to approximately 1/2 of customers electrical circuits. At the same time blocks of electrical load will be disconnected to prevent the overloaded power system from becoming unstable.

### BRIEF DESCRIPTION OF THE DRAWINGS

Drawings may not be necessary.

### DETAILED DESCRIPTION OF THE INVENTION

The disconnecting of electrical load from an overloaded power system and at the same time maintaining approximately 1/2 of the normal power service to customers is accomplished as follows:

A Frequency sensitive on/off switch is placed in either leg of the 240 volt circuit contained in the three wire, center tapped, grounded cable serving the customer.

The frequency sensitive switch will be set to open whenever the overloaded power system frequency falls below the point of which the power system may become unstable. A power system at 58 cycles is in jeopardy.

When the switches open on low power system frequency this indicates that the customers have been disconnected from the 240 volt circuit and one of the 120 volt grounded circuits.

This leaves the customers with one 120 volt grounded circuit remaining energized.

The opening of these switches will also disconnect a large block of electrical load from the overloaded power system.

The instantaneous opening of these switches on low system frequency will prevent the generators from further reducing their speed and will allow them to return to their normal 60 cycle operation.

The electrical load disconnected during the overload emergency will, in time, be picked up as more generation becomes available.

Optional means for picking up this jettisoned electrical lead are as follows:
1. Automatic reclosing of the switches as the system frequency returns to the normal 60 cycles.
2. A reset button provided for use by the customer to close the switches and restore full electrical service.
3. The transmission of electromagnetic frequencies from the power system control room to the switches on customers premises.

1. A method of disconnecting electrical load from an overloaded power system grid while maintaining part of the customers electrical circuits energized, consisting of the following steps:
a. placing an on/off switch in either leg of the 240 volt circuit of the 3 wire, center tapped, grounded cable serving said customers,
b. providing a frequency meter to monitor the frequency of said power system grid,
c. means to open said on/off switch whenever said frequency meter indicates that the frequency of said overloaded power system grid has dropped to a point at which said overloaded power system grid is in danger of becoming unstable,
Whereby the disconnecting of electrical load from said overloaded power system grid has been accomplished while maintaining part of said customers electrical circuits energized.
